(19) United States
(12) Patent Application Publication
(10) Pub. No.: US 2008/0260976 A1
(43) Pub. Date: Oct. 23, 2008

(54) CARRIER FOR CARRYING A PACKAGED CHIP AND HANDLER EQUIPPED WITH THE CARRIER

(75) Inventors: Kyoung Won Kang, Daedeok-gu (KR); Jeong Yong Moon, Goyang-si (KR); Hee Rak Beom, Seoul (KR); Jae Myeong Song, Seongnam-si (KR); Hyeong Hee Kim, Cheonan-si (KR)

Correspondence Address: KED & ASSOCIATES, LLP, P.O. Box 221200, Chantilly, VA, 20153-1200, US

(73) Assignee: Mirae Corporation

(21) Appl. No.: 12/102,409

(22) Filed: Apr. 14, 2008

(30) Foreign Application Priority Data
Apr. 18, 2007 (KR) 10-2007-0038048

(51) Int. Cl. B29D 22/00

(52) U.S. Cl. 428/34.1

(57) ABSTRACT

A carrier for carrying a packaged chip includes a housing having a space into which the packaged chip is placed and at least one guiding hole formed between outside and inside lateral surfaces thereof A moving block moves along the guiding hole and engages with a latch, which is also provided in the guiding hole. The latch rotates to hold and release a packaged chip placed into the space. Corresponding steps on the moving block and the latch prevent the latch from rotating when the moving block makes small movements caused by jolts or shocks.

### BACKGROUND

1. Field

The present disclosure relates to a carrier for carrying a packaged chip and a test handler equipped with the carrier.

2. Background

A handler puts packaged chips through electrical tests at the conclusion of a packaging process. The handler transfers the packaged chips from a user tray to a test tray and supplies the test tray containing the packaged chips to a tester. The tester includes a test board with a plurality of sockets. The handler makes the packaged chips in the test tray individually contact with sockets of the test board. The tester then performs the electrical tests on the packaged chips. After sorting the packaged chips according to test results, the handler transfers them from the test tray to the corresponding user trays.

The packaged chips are held in the test tray while they are being transferred to various locations in the handler. Each test tray is equipped with a plurality of carriers that hold the chips firmly in place. This is done to prevent the packaged chips from dropping from the test tray while the tray is being moved.

The carriers are arranged in rows and columns on a test tray. One packaged chip is placed into each carrier. When a packaged chip is placed into a carrier, a latch of the carrier holds it firmly in place. When the latch releases the packaged chip, the chip can be picked up from the carrier.

FIG. 1 is an exploded, perspective view of a configuration of a conventional carrier. As shown in FIG. 1, the carrier 1 includes a housing 10. The latch, which is mounted on the housing 10 of the carrier 1, includes a button part 12 and a pressing part 14. The pressing part 14 pushes against the packaged chip placed into the carrier 1 to hold it firmly in place. A pushing pin 20 pushes the button part 12 of the latch to release the packaged chip. Thus, the packaged chip is permitted to be picked up from the carrier 1. A pin 17, as shown in FIG. 1, connects the latch to the housing 10. The latch holds the packaged chip firmly in place by virtue of spring pressure of a coil spring 18 provided between the pin 17 and the button part 12.

The carrier 1 is subject to outside impact or shock in most environments. When the coil spring 18 does not have sufficient strength to resist such impacts, the latch fails to hold the packaged chips firmly in place. Thus, the packaged chip may be dropped from the carrier 1.

### BRIEF DESCRIPTION OF THE DRAWINGS

The embodiments will be described in detail with reference to the following drawings, in which like reference numerals refer to like elements, and wherein:

FIG. 1 is an exploded, perspective view of a configuration for a conventional carrier;

FIG. 2 is an exploded, perspective view of a first embodiment of a carrier;

FIG. 3 is a cross-sectional view of the carrier as shown in FIG. 2;

FIGS. 4A through 4E are cross-sectional views illustrating how the carrier operates;

FIG. 5 is a plan view of a handler equipped with test trays with carriers as illustrated in FIGS. 2-3; and

FIG. 6 is an exploded, perspective view of a test tray with the carriers, a pushing plate, and a plurality of suction nozzles.

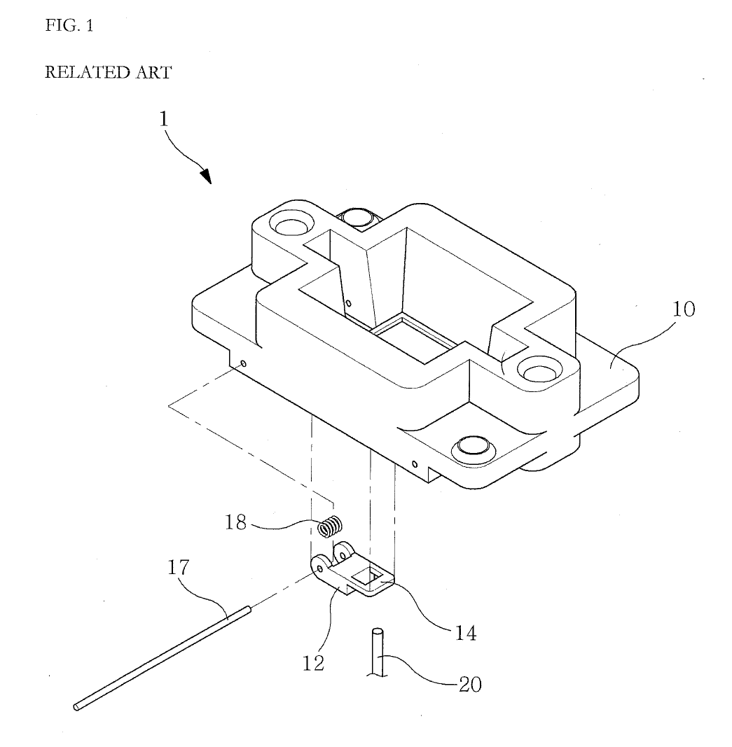

### DETAILED DESCRIPTION

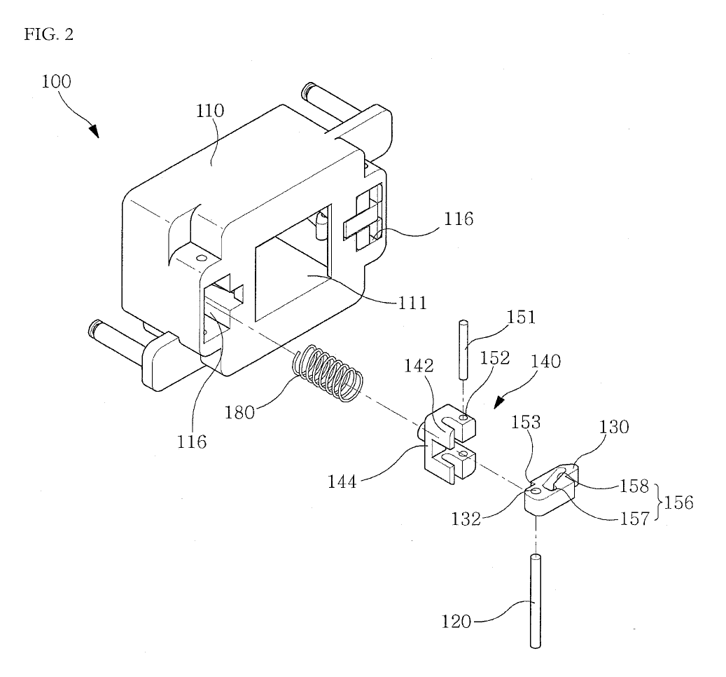

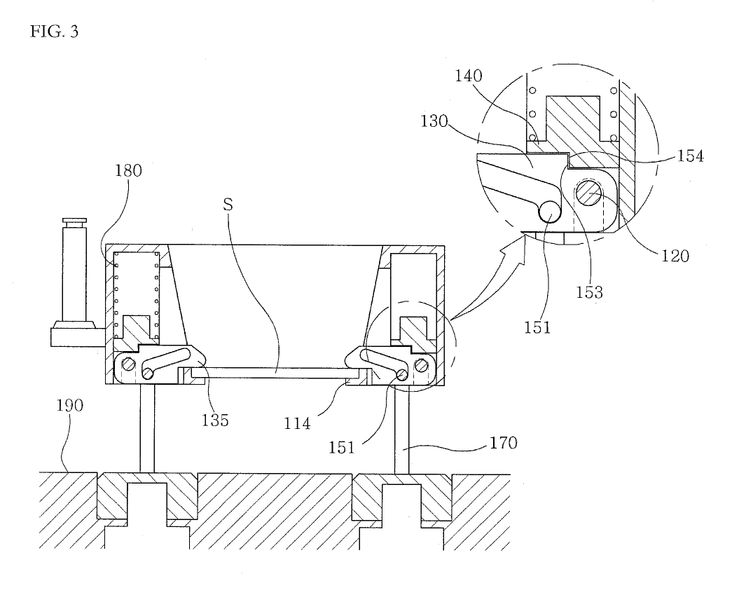

FIG. 2 is an exploded, perspective view of a first embodiment of a carrier. FIG. 3 is a cross-sectional view of the carrier as shown in FIG. 2. The carrier 100, as shown in FIGS. 2 and 3, includes a housing 110 having a space 111 in the middle thereof and a latch 130 holding firmly in place a packaged chip which is placed into the space 111. The housing 110 has two guiding holes 116, with the space 111 in between, each being located between outside and inside lateral surfaces thereof. In alternate embodiments, the housing 110 may have the two guiding holes 116 that are adjacent to each other.

One end of the guiding hole 116 is closed. An elastic member 180 is inserted into the guiding hole 116. The elastic member 180 abuts a moving block 140. The elastic member 180 applies a biasing force against the moving block 140 and the latch 130.

The moving block 140 ascends and descends within the guiding hole 116. The latch 130 is mounted to a bottom side of the moving block 140. A moving block pin 151 connects the latch 130 to the moving block 140. The latch 130 is also inserted into the guiding hole 116. A hinge pin 120 crosses the guiding hole 116 and pivotally mounts the latch 130 in the guiding hole 116. Thus, the hinge pin 120 connects the latch 130 to a body 110 of the carrier 100. The latch 130 rotates about the hinge pin 120.

The moving block 140 has a first step 154 on the bottom side which comes in contact with an upper side of the latch 130. The latch 130 has a second step 153 on its upper side, which comes in contact with the bottom side of the moving block 140. The first and second steps 154 and 153 engage with each other. The engagement of the first and second steps 154, 153 prevents the latch 130 from rotating about the hinge pin 120, in response to shocks or impacts.

The space 111 is a hole vertically pierced through the housing 110. The space 111 is where the packaged chip S is placed. The housing 110 also includes a supporting part 114 protruding from the inside lateral surface thereof toward the space 111. The supporting part 114 serves to support the packaged chip S placed into the space 111.

The latch 130 has a first hole 132 and a longitudinal hole 156. The hinge pin 120 is inserted into the first hole 132. Thus, the latch 130 rotates about the hinge pin 120.

The moving block pin 151 is inserted into the longitudinal hole 156. The moving block pin 151 moves along the longitudinal hole 156. When the moving block 140 ascends along the guiding hole 116, the moving block pin 151 travels down the longitudinal hole 156 and causes the latch 130 to rotate about the hinge pin 120, which causes the latch to release the packaged chip S.

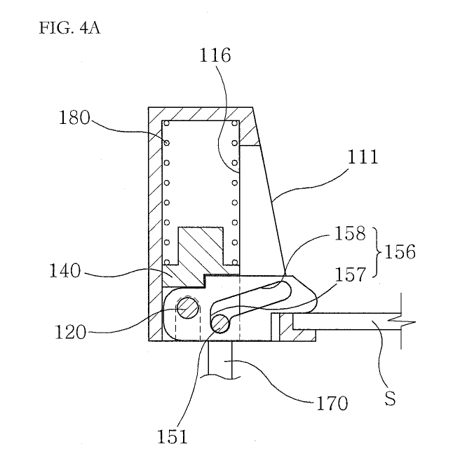

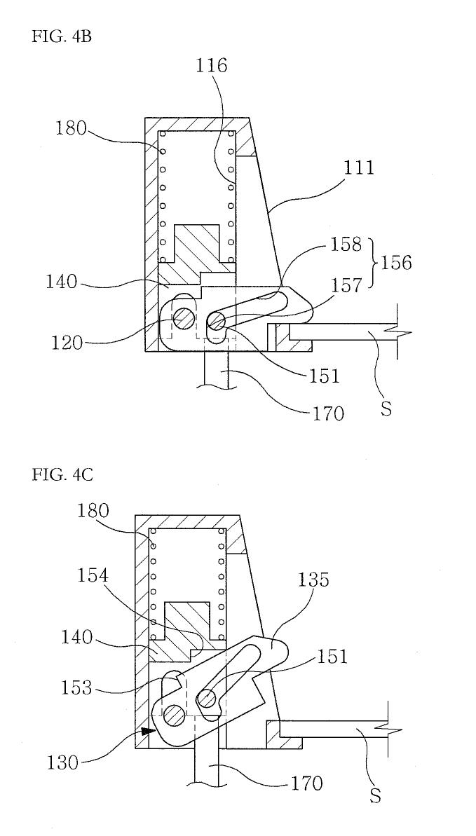

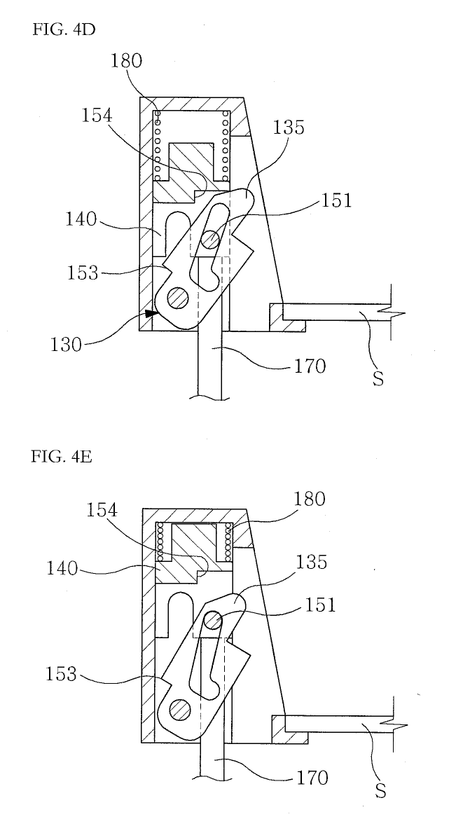

FIGS. 4A to 4E are cross-sectional views illustrating how the carrier 100 according to the present invention operates.

As shown in FIGS. 3 and 4A, when no force is applied to the moving block 140 by a pushing pin, the moving block 140 pushes against the latch 130 by virtue of the biasing force of the elastic member, such as a coil spring 180, and the latch 130 holds the packaged chip S firmly in place in the space 111.

When a pushing pin 170, positioned under the latch 130, pushes the moving block 140 upward in the guiding hole, the moving block 140 ascends to rotate the latch 130 about the hinge pin 120, resulting in releasing the package chip S. That is, when the moving block 140 ascends, the moving block pin 151 moves along the longitudinal hole 156 to rotate the latch 130

The moving block 140 has a first step 154 on the bottom side thereof which engages with a second step on the upper side of the latch 130 to prevent the latch 130 from rotating during the initial upward movement of the moving block 140. The first and second steps 154 and 153 are the same in height. The height of the first and second steps 154 and 153 is hereinafter referred to as a “critical height.” When the moving block 140 moves upward by the critical height, as shown in FIG. 4B the first and second steps 154 and 153 are disengaged from each other, permitting the latch 130 to begin to rotate about the hinge pin 120.

The longitudinal hole 156 in the latch includes a first longitudinal section 157 and a second longitudinal section 158. The first longitudinal section 157 serves to provide a path which the moving block pin 151 follows to move upwards by the amount of the critical height while the latch 156 remain in the latched position. The second longitudinal section 158 serves as a path which the moving blocks pin 151 follows when the moving block 140 has passed the critical height. When the moving block pin 151 moves along the second longitudinal section 158, the latch 130 rotates about the hinge pin 120 to release the packaged chip S.

When the latch 130 holds the packaged chip firmly in place, the first longitudinal section 157 remains upright and the second longitudinal section 158 remains inclined upwards toward a pressing part 135 of the latch 130. The length of the first longitudinal section 157 may be equal to or greater than the critical height to permit the first and second steps 154 and 153 to remain engaged with each other when the moving block 140 ascends short distances up the guiding hole 116.

As shown in FIG. 2, the moving block 140 includes a head part 144 in the shape of a hexahedron and a leg part 142. The leg part 142 has second holes 152 into which the moving block pin 151 is inserted. The head part 144 may have the first step 154 on the bottom side, which engages with the second step 153 on the latch.

The head part 144 is inserted into the guiding hole 116. The leg part 142 includes four legs, each of which protrudes downward from each of the bottom corners of the head part 144. Two of the legs protruding from one side have the second holes 152. The latch 130 is inserted between the two legs having the second holes 152. The moving block pin 151 passes through the second holes 152 and the longitudinal hole 156 on the latch to connect the moving block 140 to the latch 130. The second holes 152 serve only to fix the moving block pin 151 to the moving block 140. Therefore, the moving block pin 151 and the two legs may be formed as a single body. Otherwise, the moving block pin 151 may be connected to the two legs, with a connecting means such as a rivet.

As shown in FIG. 3, a pushing plate 190, on which pushing pins 170 are provided, is positioned under a test tray equipped with the carriers. The pushing pins 170 push the moving blocks 140 upward. A pair of the pushing pins 170 may push against the two legs of a single moving block 140. The pushing pins 170 are provided in a pair to stably push the moving block 140. However, in alternate embodiments, only one pushing pin 170 may be provided for each moving block 140.

Until the pushing pin 170 pushes the moving block 140 upward more than the critical height, the first step 154 on the moving block 140 and the second step 153 on the latch 130 remain engaged with each other and the latch 130 does not rotate. When the pushing pin 170 pushes the moving block 140 upward more than the critical height, as shown in FIG. 4B, the first step 154 on the moving block 140 and the second step 153 on the latch 130 are disengaged from each other, which allows the moving block pin 151 to move along the second longitudinal section 158, thereby causing the latch to rotate. The moving block 140 continues to ascend until the moving block pin 151 reaches the upper end of the second longitudinal section 158 on the latch 130. Thus, the latch 130 can rotate about the hinge pin 120 to release the packaged chip S.

When the moving block pin 151 moves to an upper end of the second longitudinal hole 158, the latch 130 does not protrude into the space 111, which allows the packaged chip S to be loaded into or removed from the space 111. During a loading step, a vacuum nozzle of a picker places a packaged chip S into the space 111, and the pushing pin 170 descends. When the pushing pin 170 descends, the moving block 140 descends by virtue of spring pressure of the coil spring 180 provided into the guiding hole 116, which rotates the latch 130 back to the closed and latched position, as shown in FIG. 4A. Thus, the packaged chip S is held firmly in place.

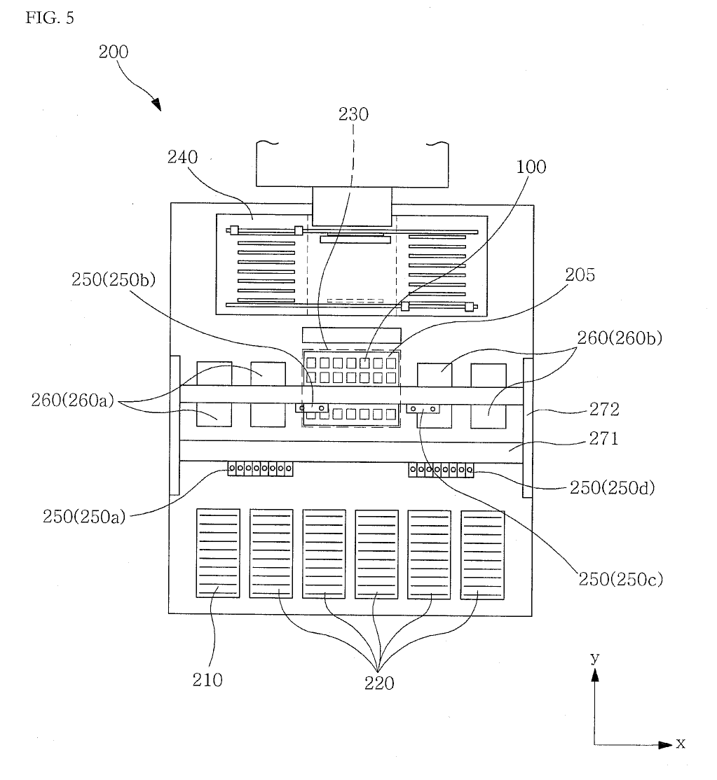

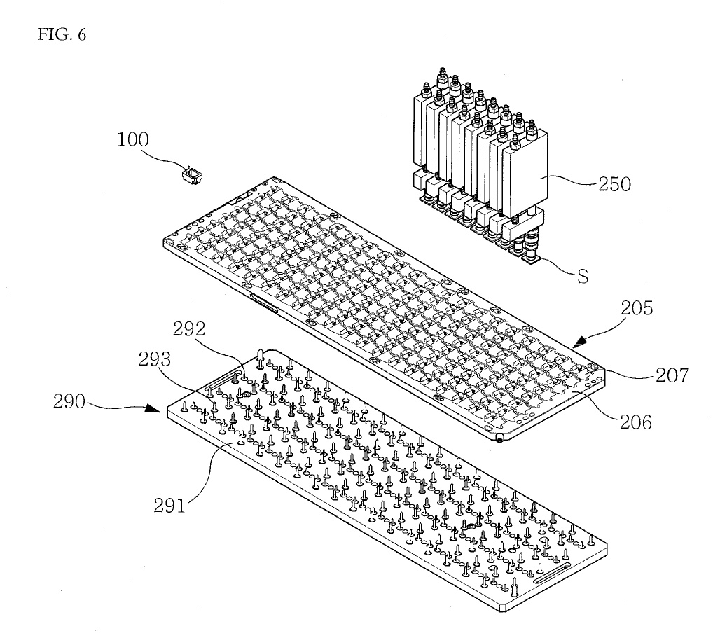

FIG. 5 is a plan view of a handler equipped with test trays having the carriers described above. FIG. 6 is an exploded, perspective view of a test tray with the carriers and a pushing plate.

As shown in FIG. 5 the handler includes an exchanging site 230, a picker assembly 250, and a pushing plate 290 (refer to FIG. 6). The exchanging site 230 is where the packaged chips are loaded into the test tray and where the tested packaged chips are unloaded from the test tray to be transferred to user trays. The tested packaged chips are graded according to test results and the graded tested packaged chips are loaded into their corresponding user trays staying in a stacker 220.

The test tray 205 includes the carriers 100 described above. The packaged chips are placed into the carriers 100.

The handler includes at least one picker (250a, 250b, 250c, or 250d) to load the packaged chips S into or unload them from the test tray. The loading picker picks up the packaged chip S from the trays 210 to place them into the carriers of the test tray 205, and the unloading picker picks up the tested packaged chip S from the carriers 100 of the test tray 205 to place them into the second user tray 220.

As shown in FIG. 5, the loading picker may include a first picker 250a picking up the packaged chips S from the first user tray 210 to place them on a first buffer unit 260a and a second picker 250b picking up the packaged chips S from the buffer unit 260a to place them into the carrier of the test tray. As shown in FIG. 5, the unloading picker may include a third picker 250c picking up the tested packaged chips S from the test tray to place them on a second buffer unit 260b and a fourth picker 250d picking up the tested packaged chips S from the second buffer to place them into the second user tray 220. The pickers are provided on X-axis and Y-axis gantries 271 and 272, and are movable along the X-axis gantry 271 and the Y-axis gantry 272. Of course, other embodiments may have different numbers of pickers and gantries.

The handler may further include a test system 240. The test system 240 includes several chambers, provided behind the handler, where the packaged chips contained in the test tray are heated or cooled to extremely high or low temperatures, tested, and cooled or heated to room temperature. Among them, the test chamber is where the packaged chips come in contact with sockets of a test board in an outside tester to receive electrical tests.

The carriers 100 are provided on the test tray 205. The carriers 100 hold the packaged chips S firmly in place while the test tray 205 containing them moves in the handler. As shown in FIG. 6, the test tray 205 may include a frame 206 and sockets 207. The carriers 100 are provided on the sockets 207.

A pushing plate 290 is positioned under the test tray 205. The pushing plate 290 releases the latches of the carriers provided on the test tray 205 as described above. As shown in FIG. 6, the pushing plate 290 includes a base plate 291 and pushing pins 292. The pushing plate 290 is movable upwards and downwards by a driving unit (not shown). The pushing pins 292 are provided on an upper side of the base plate 291 to release the latches of the carriers 100 provided on the test tray 205.

The base plate 291 may further include guiding pins 293. The guiding pins 293 are also provided on an upper side of the base plate 291, adjacent to the pushing pins 292. The guiding pin 293, which are longer than the pushing pins 292, are inserted into guiding holes ahead of the pushing pins 282. Thus, the guiding pins 293 guide the pushing pins 292 to exactly push the latch.

One pushing plate may ascend to push the moving blocks 140 of all of the carriers at the same time.

The carrier described above provides an advantage of holding the packaged chips firmly in place when shocks or jolts cause small movements of the moving blocks. Thus the packaged chips are prevented from dropping from the carrier while the test tray containing them moves in the handler.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although a number of embodiments have been described, it should be understood that numerous other modifications and embodiments can be devised by those skilled in the art that will fall within the spirit and scope of the principles of this disclosure. More particularly, variations and modifications are possible in the component parts and/or arrangements that would fall within the scope of the disclosure, the drawings and the appended claims. In addition to variations and modifications in the component parts and/or arrangements, alternative uses will also be apparent to those skilled in the art.

What is claimed is:

1. A carrier for holding a packaged chip, comprising:
a housing having a holding space into which a packaged chip is received, wherein a guiding hole is formed in the housing beside the holding space;
a moving block that is movably mounted in the guiding hole; and
a latch that is pivotally mounted adjacent an end of the guiding hole, wherein the latch is coupled to the moving block such that the latch rotates as the moving block moves along the guiding hole, and wherein the latch rotates between a closed position at which the latch holds a packaged chip in the holding space and an open position which allows a packaged chip to be mounted in or removed from the holding space.

2. The carrier of claim 1, wherein the latch has a channel that extends along its length, and further comprising a moving block pin that is attached to the moving block and which passes through the channel in the latch to couple the moving block to the latch such that as the moving block moves in the guiding hole, the latch is rotated.

3. The carrier of claim 2, wherein the latch comprises a pivot hole, and further comprising a hinge pin that extends through the pivot hole of the latch and that is attached to the housing.

4. The carrier of claim 2, wherein a latch step is formed on a side of the latch that faces the moving block, and wherein a moving block step is formed on a side of the moving block that faces the latch, and wherein the latch step engages with the moving block step when the latch is in the closed position to prevent the latch from rotating.

5. The carrier of claim 4, wherein the latch step remains engaged with the moving block step to prevent rotation of the latch while the moving block moves along the guiding hole less than a critical distance.

6. The carrier of claim 5, wherein when the moving block moves along the guiding hole more than the critical distance, the latch step disengages from the moving block step to allow the latch to rotate.

7. The carrier of claim 6, wherein the critical distance is approximately equal to a height of one of the latch step and the moving block step.

8. The carrier of claim 5, wherein the channel in the latch comprises a first section that extends in a direction that is approximately parallel to a moving direction of the moving block, and a second section that extends at angle with respect to the first section.

9. The carrier of claim 8, wherein the moving block pin moves along the first section of the channel in the latch as the moving block moves along the guiding hole less than the critical distance.

10. The carrier of claim 9, wherein the moving block pin moves along the second section of the channel of the latch when the moving block moves along the guiding hole more than the critical distance.

11. The carrier of claim 1, further comprising an elastic member mounted in the guiding hole, wherein the elastic member applies a biasing force to the moving block that urges the moving block towards the latch.

12. The carrier of claim 1, wherein first and second guiding holes are formed in the housing on opposite sides of the holding space, and wherein a moving block and a latch are provided in each of the first and second guiding holes.

13. A test tray comprising the carrier of claim 1, wherein a plurality of carriers are mounted on the test tray.

14. A test handler comprising the test tray of claim 13.

15. The test handler of claim 14, wherein the test handler further comprises a pushing unit that pushes the moving blocks of the carriers on the test tray to cause the moving blocks to move upward and downward within their respective guiding holes.

16. The test handler of claim 15, wherein the pushing unit comprises:
a pushing plate;
a plurality of pushing pins that protrude upward from the pushing plate; and
a driving unit that moves the pushing plate upwards and downwards with respect to the test tray such that the pushing pins simultaneously push the moving blocks of carriers upwards and downwards within their respective guiding holes.

17. A carrier for holding a packaged chip, comprising:
a housing having a holding space into which a packaged chip is received, wherein a guiding hole is formed in the housing beside the holding space;
a latch that is pivotally mounted adjacent a first end of the guiding hole; and
a rotation mechanism that is mounted in the guiding hole, wherein the rotation mechanism operates to cause the latch to rotate between a closed position where the latch holds a packaged chip in the holding space and an open position which allows a packaged chip to be mounted in or removed from the holding space, wherein if the rotation mechanism moves less than critical distance, the latch does not rotate, and wherein if the rotation mechanism moves more than the critical distance, the latch begins to rotate.

18. The carrier of claim 17, wherein the rotation mechanism comprises:
a moving block that is movably mounted in the guiding hole between the latch and a second end of the guiding hole; and
a biasing member mounted in the guiding hole between the moving block and the second end of the guiding hole such that the biasing member applies a biasing force to the moving block that urges the moving block towards the latch.

19. The carrier of claim 18, wherein a latch step is formed on a side of the latch that faces the moving block, wherein a moving block step is formed on a side of the moving block that faces the latch, and wherein the latch step engages with the moving block step when the latch is in the closed position to prevent the latch from rotating when the moving block moves less than the critical distance.

20. The carrier of claim 19, wherein the critical distance is approximately equal to a height of one of the latch step and the moving block step.
